(19) United States
(12) Patent Application Publication
(10) Pub. No.: US 2012/0290839 A1
(43) Pub. Date: Nov. 15, 2012

(54) METHOD AND SYSTEM OF COMMUNICATING INFORMATION DISPLAYED AT A PUBLISHER DEVICE WITH A RECEIVER DEVICE

(76) Inventors: Rajesh Jayaraman, New York, NY (US); Scott Walter Pitts, San Francisco, CA (US)

(21) Appl. No.: 13/106,771

(22) Filed: May 12, 2011

(51) Int. Cl. H04L 9/32; G06F 15/16

(52) U.S. Cl. 713/168

(57) ABSTRACT

The invention provides a method of communicating a display of information at a publisher device with a receiver device for display at the receiver device, the method including receiving a push-through packet from the publisher device at a connect server, including data entered at the publisher device and a key, receiving a key from the receiver device, comparing the keys received from the publisher and receiver devices to determine if a match exists and transmitting a push-through packet, including the data, from the connect server to the receiver device if a match exists between the keys received from the publisher and receiver devices.

### BACKGROUND OF THE INVENTION

1). Field of the Invention

This invention relates to a method and system of communicating information displayed at a publisher device with a receiver device for display at the receiver device.

2). Discussion of Related Art

Organizations such as banks and insurance companies often have online forms that can be filled out by a user. The user will direct a browser application to request a web page from a host server and the host server will respond to the request by returning a web page for display by the browser application. The web page may have fields where a user can enter data using an input device. After the user has completed the data on the web page, the user can select a button that transmits the data to the host server.

It has been found that a user will often complete only a portion of the data and then discontinue. The user quits out of the web page due to confusion perceived by the user or because the user may feel overwhelmed by the entire process. As such, the data is never is received by the host server and an opportunity by the organization to complete a transaction is lost.

### SUMMARY OF THE INVENTION

The invention provides a method of communicating a display of information at a publisher device with a receiver device for display at the receiver device, the method including receiving a push-through packet from the publisher device at a connect server, including data entered at the publisher device and a key, receiving a key from the receiver device, comparing the keys received from the publisher and receiver devices to determine if a match exists and transmitting a push-through packet, including the data, from the connect server to the receiver device if a match exists between the keys received from the publisher and receiver devices.

The method may further include transmitting a connect-to-publisher initialization packet from the connect server to the publisher device, including a packet assembly script that assembles the data and the key into the push-through packet at the publisher device and a transmission script that transmits the push-through packet from the publisher device to the connect server.

The method may further include that the packet assembly script and the transmission script may be connected to a clock of the publisher device and repeatedly at select intervals respectively assemble and transmit the push-through packet.

The method may further include that the publisher device downloads a host-to-publisher packet from a host server, including a web page that is displayed at the publisher device for viewing of the data and the key and, an initialization script that downloads the connect-to-publisher initialization packet from the connect server onto the publisher device.

The method may further include that the push-through packet that may be assembled by the packet assembly script may include the web page.

The method may further include generating a plurality of unique keys, transmitting a plurality of connect-to-publisher initialization packets, each including a different one of the unique keys, to a plurality of respective publisher devices, receiving a push-through packet from the respective one of the publisher devices, the respective push-through packet including the unique key transmitted to the respective publisher device, storing the respective push-through packets and selecting the push-through packet based on the key received from the receiver device.

The method may further include that the connect-to publisher initialization packet may include masking rules that are used by the packet assembly script to include a first subset of the data in the push-through packet while not including a second subset of the data in the push-through packet.

The method may further include transmitting a connect-to-receiver initialization packet from the connect server to the receiver device, including a key entry page that is displayed at the receiver device with a field for displaying the key when the key is entered using an input device of the receiver device, a key submission script that transmits the key from the receiver device to the connect server and a reception script that receives the push-through packet from the connect server for display of the data by the receiver device.

The method may further include that the key submission script and the reception script may be connected to a clock of the receiver device and repeatedly at select intervals respectively transmit the key and receive a respective push-through packet.

The method may further include that the receiver device downloads a host-to-receiver packet from a host server, including a web page skeleton that is displayed at the receiver device, and an initialization script that downloads the connect-to-receiver initialization packet from the connect server onto the receiver device.

The method may further include receiving a push-through packet from the receiver device at a connect server, including data entered at the receiver device and a key, receiving a key from the publisher device, comparing the keys received from the receiver and publisher devices to determine if a match exists and transmitting a push-through packet, including the data, from the connect server to the publisher device if a match exists between the keys received from the receiver and publisher devices.

The method may further include transmitting a connect-to-publisher initialization packet from the connect server to the publisher device, including an encrypt password generator that generates an encryption password and an encryption logic that encrypts the push-through packet with the encryption password to create an encrypted push-through packet, receiving the encrypted push-through packet from the publisher device at the connect server, transmitting the encrypted push-through packet from the connect server to the receiver device and transmitting a connect-to-receiver initialization packet from the connect server to the receiver device, including a receiver that receives the encrypted push-through packet, a key entry page for entering an encryption password and a decrypter that decrypts the encrypted push-through packet with the encryption password entered on the key entry page only if the encryption password entered on the key entry page matches the encryption password generated by the encryption logic.

The invention further provides a connect server for communicating a display of information at a publisher device with a receiver device for display at the receiver device, the connect server comprising a processor, a storage medium connected to the processor, a network interface device connected to the processor and a set of instructions and data on the storage medium, including a reception unit that executes the processor to receive a push-through packet through the network interface device from the publisher device including data entered at the publisher device, and for receiving a key from the receiver device, a key comparison module that compares the keys received from the publisher and receiver devices to determine if a match exists and a transmission unit that executes the processor to transmit a push-through packet, including the data to the receiver device if a match exists between the keys received from the publisher and receiver devices.

### BRIEF DESCRIPTION OF THE DRAWINGS

The invention is further described by way of example with reference to the accompanying drawings, wherein:

FIG. 1 is a block diagram of a network system, according to an embodiment of the invention;

FIGS. 2A-D are block diagrams of a host server, publisher device, connect server and receiver device forming part of the network system;

FIG. 3A is a block diagram of the host server, publisher device, connect server and receiver device illustrating that functioning of the publisher device and the receiver device is switched around;

FIG. 3B is a block diagram of the host server, publisher device, connect server and receiver device illustrating how encryption capabilities are distributed from the connect server to the publisher and receiver devices and used by the publisher and receiver devices to encrypt and decrypt a push-through packet;

FIG. 4 is a block diagram of a machine in the form of a computer system that can be used for any of the devices or servers of the network system;

FIGS. 5A and B are screen shots of the publisher and receive devices, respectively, before the receiver device receives any data from the publisher device;

FIGS. 6A and B are screenshots of the publisher and receiver devices, respectively, after a key is generated and displayed on a display of the publisher device and a key entry page is displayed at the receiver device;

FIGS. 7A and B are screenshots of the publisher and receiver devices, respectively, after a user at the receiver device has entered the key;

FIGS. 8A and B are screenshots of the publisher and receiver devices, respectively, after the same web page and data on the publisher device are received and displayed at the receiver device;

FIGS. 9A and 9B are screenshots of the publisher and receiver devices, respectively, after the data has been transmitted from the publisher device to the host server, and further illustrating the ability for the publisher device to switch so that it can receive data from the receiver device;

FIGS. 10A and B are screenshots of the publisher and receiver devices, respectively, after a completed form is returned from the host server to the publisher device and the same form is displayed at the receiver device; and

FIG. 11 is a screenshot of the receiver device after the user at the publisher device has electronically signed the form.

### DETAILED DESCRIPTION OF THE INVENTION

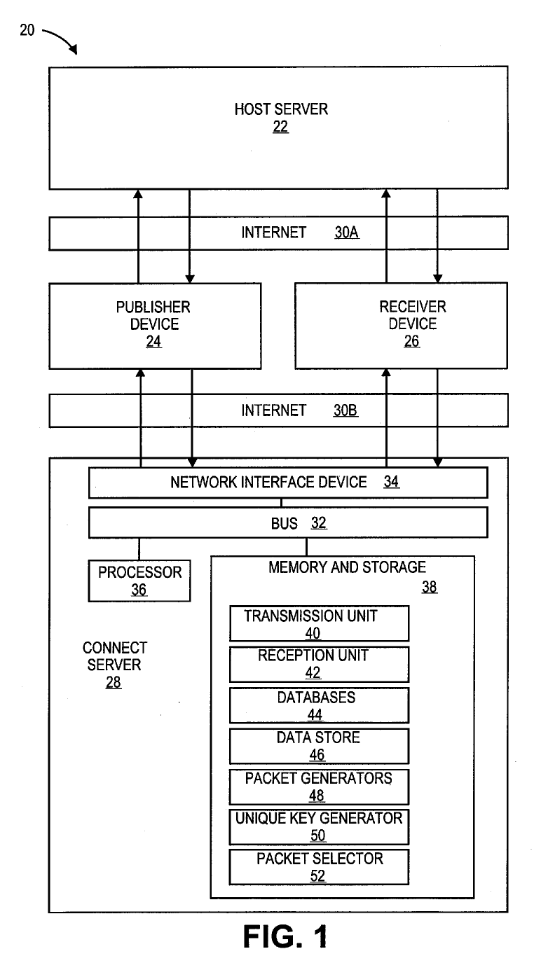

FIG. 1 of the accompanying drawings illustrates a network system 20, according to an embodiment of the invention, including a host server 22, publisher and receiver devices 24 and 26 respectively, and a connect server 28. The publisher device 24 is connected over the Internet 30A with the host server 22 and over the Internet 30B with the connect server 28. Similarly, the receiver device 26 is connected over the Internet 30A with the host server 22 and over the Internet 30B with the connect server 28.

The connect sever 28 includes a bus 32, a network interface device 34 connected to the bus 32, a processor 36 connected to the bus 32, and memory and storage 38 connected to the bus 32. A set of instructions in the form of a number of software modules are stored on the memory and storage 38, including a transmission unit 40, a reception unit 42, databases 44, a data store 46, packet generators 48, a unique key generator 50, and a packet selector 52.

The network interface device 34 provides an interface for sending and receiving signals over the Internet 30B. The transmission unit 40 is executable by the processor 36 to cause transmission of signals by the network interface device 34 over the Internet 30B to the publisher device 24 or the receiver device 26. The reception unit 42 is executable by the processor 36 to receive signals from the publisher device 24 or the receiver device 26 over the Internet 30B at the network interface device 34. Functioning of the other software modules within the memory and storage 38 will become evident in the description that follows. Furthermore, only components of the connect server 28 are shown in FIG. 1. It should however be understood that the host server 22 and the publisher and receiver devices 24 and 26 respectively have similar components as will become evident in the description that follows. For example, the publisher device 24 has a bus, a network interface device, a processor, memory and storage, and a number of software modules residing on the memory and storage thereof that are executable by the processor thereof.

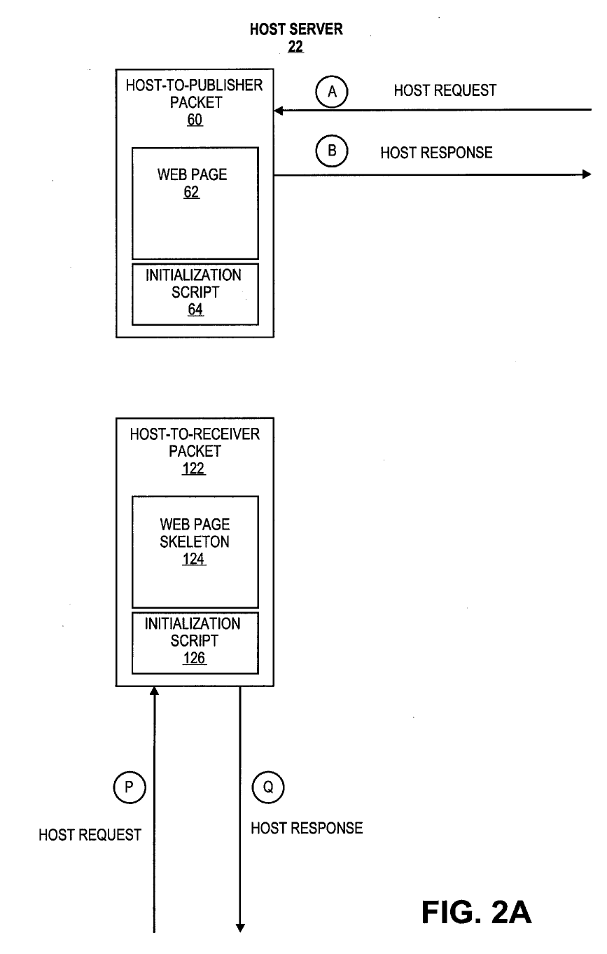

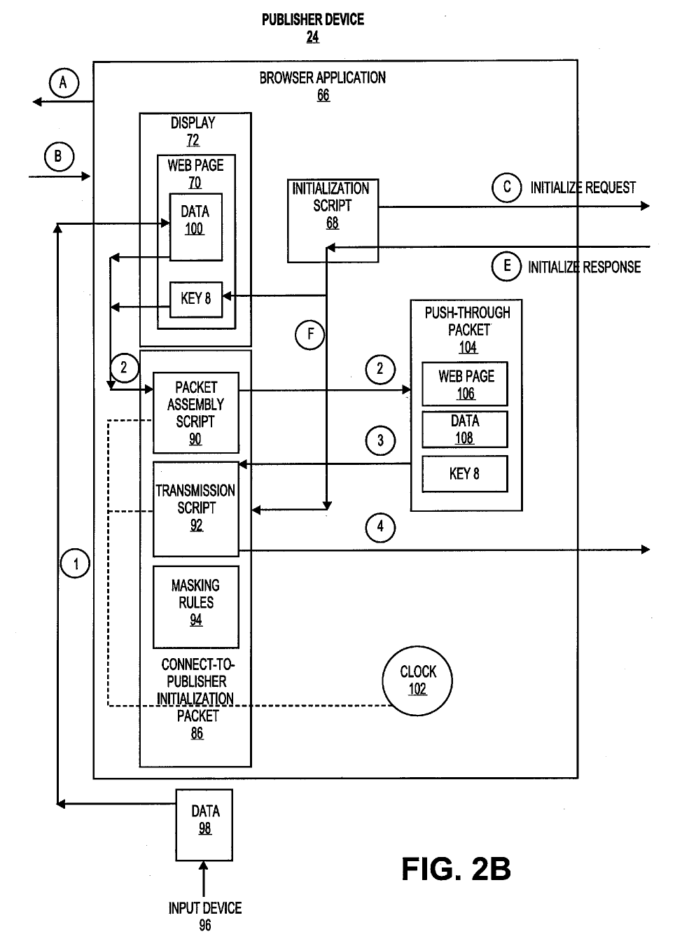

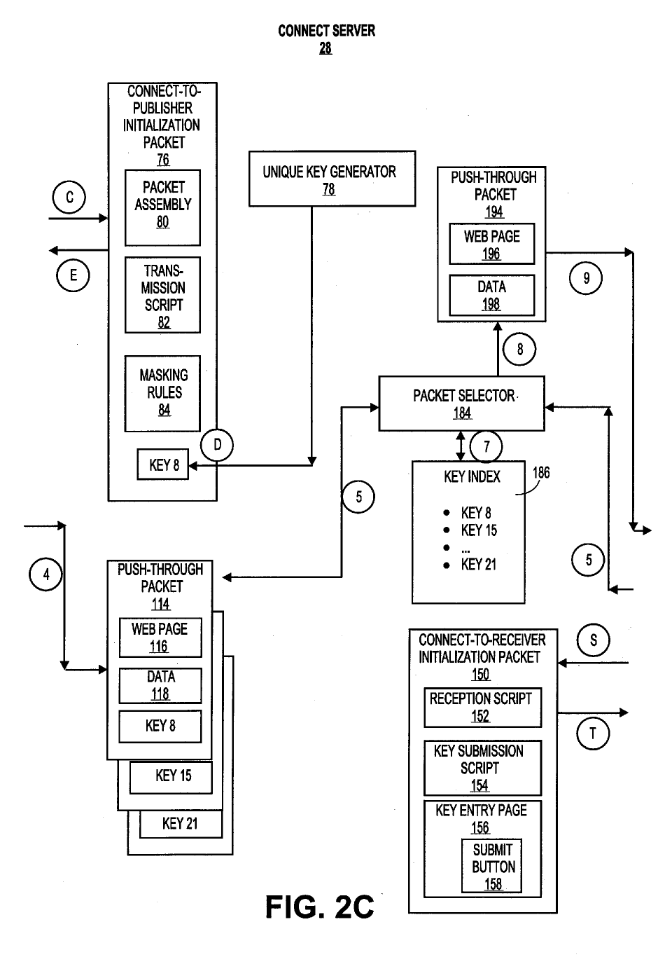

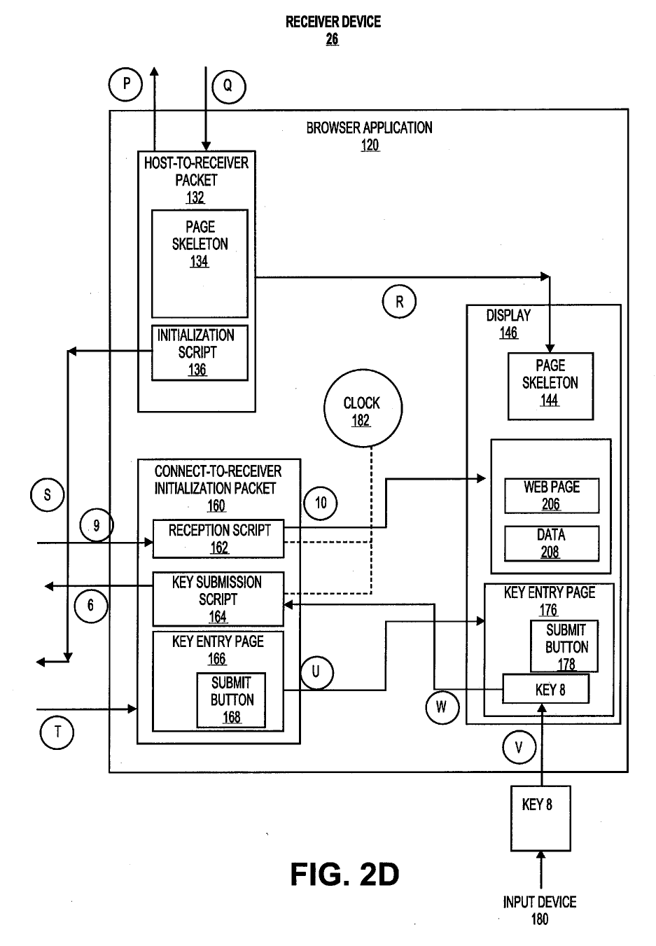

FIGS. 2A-D illustrate components of the host server 22, publisher device 24, connect server 28 and receiver device 26, respectively. FIGS. 2A-D can be placed side-by-side from left-to-right for the reader to gain a full picture of the interaction between the host server 22, publisher device 24, connect server 28 and receiver device 26. The bottom edge of FIG. 2A also matches up with the top edge of FIG. 2D. Extra details such as the Internet 30A and 30B in FIG. 1 and components of the connect server 28 such as the transmission and reception units 40 and 42 are not shown in FIGS. 2A-D so as not to obscure other functional details. Signals A-F are one-time signals for initialization of the publisher device 24. Signals P-W are one-time signals for initialization of the receiver device 26. Signals 1-10 are transmitted multiple times based on a clock signal or an event.

In FIG. 2A, the host server 22 includes a host-to-publisher packet 60 that includes a web page 62 and an initialization script 64. The initialization script 64 is previously received from the connect server 28 in FIG. 2C and is attached to the web page 62 by an administrator of the host server 22.

Referring to FIGS. 2A and 2B in combination, the publisher device 24 includes a browser application 66 that is used to transmit a host request signal A from the publisher device 24 to the host server 22. The host server 22 receives the host request signal A and responds to the host request signal A by transmitting a host response signal B that includes the host-to-publisher packet 60. The browser application 66 receives the host response signal B including the web page 62 and the initialization script 64. The browser application 66 then stores the initialization script 64 as the initialization script 68. The browser application 66 also displays the web page 62 as a web page 70 on a display 72 of the publisher device 24.

What should be noted is that no plug-in is downloaded by a user of the publisher device 24 from the host server 22. The user of the publisher device 24 simply navigates the browser application 66 to the host server 22, which causes automatic downloading of the initialization script 68 onto the publisher device 24 without requiring a separate install of a plug-in.

Referring to FIGS. 2B and 2C collectively, the connect server 28 has a connect-to-publisher initialization packet 76 and a unique key generator 78. The unique key generator 78 generates a unique key, for example key 8 represented as signal D. The connect-to-publisher initialization packet 76 includes a packet assembly script 80, a transmission script 82, masking rules 84 and the key 8. The initialization script 68 at the publisher device 24 automatically transmits an initialize request signal C to the connect server 28. The connect server 28 receives the signal C and automatically in response thereto transmits an initialize response signal E. The initialize response signal E is received by the initialization script 68 at the publisher device 24.

As further illustrated in FIG. 2B, the initialization script 68 displays the key 8 within the web page 70. The initialization script 68 also stores the connect-to-publisher initialization packet 76 received from the connect server 28 in FIG. 2C as a connect-to-publisher initialization packet 86 that includes a packet assembly script 90, a transmission script 92 and masking rules 94. The connect-to-publisher initialization packet 86 stored in the publisher device 24 is thus identical to the connect-to-publisher initialization packet 76 stored in the connect server 28, except for the key 8.

What should be noted is that no plug-in is downloaded from the connect server 28 onto the publisher device 24. Furthermore, any communication between the publisher device 24 and the connect server 28 is invisible to the user of the publisher device 24. The initialization script 68 automatically downloads and stores the connect-to-publisher initialization packet 86 without requiring a separate install of a plug-in.

The publisher device 24 further includes an input device 96. A user uses the input device 96 to enter data 98 into memory. The data 98 is also displayed as data 100 within the web page 70. The web page 70 is typically in a form with a number of fields for entering the data. Signal 1 represents the continual update of the data 100 based on data 98 entered by the user using the input device 96.

The publisher device 24 further includes a clock 102. The packet assembly script 90 and the transmission script 92 are both connected to the clock 102. The packet assembly 90 and the transmission script 92 are responsible for signals 2-4 that are executed on a periodic basis, for example every 5 seconds, based on timing provided by the clock 102.

The packet assembly script 90 receives the web page 70, the data 100 and the key 8 that are displayed on the display 72 and assembles them as a push-through packet 104 represented by signal 2. The push-through packet 104 thus includes a web page 106 that is the same as the web page 70, data 108 that is the same as the data 100, and the key 8. The web page 106 is thus the same web page as the web page 62 received from the host server 22 in FIG. 2A, the data 108 is the same data as the data 98 entered by the input device 96 in FIG. 2B, and the key 8 is the same as the key 8 generated by the unique key generator 78 in FIG. 2C.

Once the push-through packet 104 has been assembled, the transmission script 92 receives the push-through packet 104 at signal 3 and transmits the push-through packet 104 at signal 4 to the connect server 28 in FIG. 2C. Referring more specifically to FIG. 2C, the connect server 28 receives the signal 4 in FIG. 2B and stores the push-through packet 104 as a push-through packet 114. The push-through packet 114 has a web page 116, data 118 and the key 8 that are identical to the web page 106, the data 108 and the key 8 of the push-through packet 104 in FIG. 2B. The push-through packet 114 is stored among a plurality of push-through packets, represented by keys 8, 15 and 21 respectively. Each push-through packet has a unique key and a unique set of data such as the data 118. The push-through packet 114 and the plurality of push-thorough packets are stored within the data store 46 in FIG. 1.

A user at the receiver device 26 may for example be someone providing supporting advice to a user at the publisher device 24. As the user at the publisher device 24 enters the data 100 onto the web page 70, the user may require support with one or more entries and may then call a help line that will connect the user at the publisher device 24 with a user at the receiver device 26. The user at the receiver device 26 may ask the user at the publisher device 24 for the URL of the host server 22 in FIG. 2A or may already know the URL of the host server 22.

The user at the receiver device 26 will then utilize a browser application 120 of the receiver device 26 to transmit a host request signal P from the receiver device 26 to the host device 22. As shown in FIG. 2A, the host request signal P is received by the host server 22. The host server 22 then automatically responds to the host request signal P by transmitting a host response signal Q from the host server 22 to the receiver device 26. The host server 22 includes a host-to-receiver packet 122 that includes a web page skeleton 124 and an initialization script 126. The host-to-receiver packet 122 is transmitted as part of the host response signal Q to the receiver device 26.

As shown in FIG. 2D, the receiver device 26 receives the host response signal Q. The receiver device 26 stores the host-to-receiver packet 122 of the host server 22 as a host-to-receiver packet 132 that includes a web page skeleton 134 and an initialization script 136 that are identical to the web page skeleton 124 and the initialization script 126 of the host-to-receiver packet 122 in FIG. 2A. The browser application 120 displays the web page skeleton 124 as a web page skeleton 144 within a display 146 of the receiver device 26, represented as signal R.

What should be noted is that no plug-in is installed by the receiver device 26 from the host server 22. The initialization script 136 is automatically downloaded by the receiver device 26 when a user of the receiver device 26 directs the browser application 120 to the host server 22.

Referring to FIGS. 2C and 2D in combination, the initialization script 136 transmits a request signal S from the receiver device 26 to the connect server 28. The connect server 28 receives the request signal S and automatically responds to the request signal S by transmitting a response signal T from the connect server 28 to the receiver device 26. The response signal T includes a connect-to-receiver initialization packet 150. The connect-to-receiver initialization packet 150 includes a reception script 152, a key submission script 154 and a key entry page 156 with a submit button 158, all of which are transmitted in the response signal T. The receiver device 26 receives the response signal T and stores the connect-to-receiver initialization packet 150 in FIG. 2C as a connect-to-receiver initialization packet 160 with a reception script 162, a key submission script 164 and a key entry page 166 with a submit button 168.

What should be noted is that no plug-in is downloaded from the connect server 28 onto the receiver device 26. The initialization script 136 automatically causes download and storing of the connect-to-receiver packet 160 without the need for a separate download and install of a plug-in. Any communication between the receiver device 26 and the connect server 28 in invisible to a user of the receiver device 26 up to this point.

Represented by signal U, the key entry page 166 and the submit button 168 are displayed on the display 146 as a key entry page 176 and submit button 178. The key entry page 176, and the key entry pages 166 and 156 have a field for entering a key. The user at the receiver device 26 can use an input device 180 of the receiver device 26 to enter a key. The user at the receiver device 26 typically has a telephone discussion with the user at the publisher device 24 in FIG. 2B, at which time the user at the publisher device 24 verbally communicates the key 8 with the user at the receiver device 26. The user at the receiver device 26 then uses the input device 180 to enter the key 8 into memory and the key 8 is then displayed within the key entry page 176, represented by signal V.

As represented by signal W, the key submission script 164 receives the key 8 in a single (i.e. not repeated) operation. The receiver device 26 further includes a clock 182 and both the key submission script 164 and the reception script 162 are connected to the clock 182. Signals 6, 9 and 10 are executed by the key submission script 164 and the reception script 162 based on an input provided by the clock 182. The signals 6, 9 and 10 may for example be executed at 5 second intervals. Signals 5 and 7-9 in FIG. 2C are executed in response to signal 6, i.e. also automatically approximately every 5 second intervals.

The function of the key submission script 164 is to transmit the key 8 from the receiver device 26 in signal 6 to the connect server 28. The connect server 28 includes a packet selector 184 and a key index 186. The packet selector 184 receives the signal 6, including the key 8, and compares the key with keys in the key index 186 to determine whether a match exists and to determine which ones of the keys in the key index 186 is a match. The look-up function of the packet selector 184 is represented by signal 7. Only if a match exists between the key 8 received by the packet selector 184 and a key in the key index 186 is one of the push-through packets represented by the push-through packet 114 extracted. Each one of the keys in the key index 186 corresponds with a respective one of the push-through packets represented by keys 8, 15 and 21 of the push-through packets 114. In the present example, the packet selector 184 receives the key 8 in the signal 6 and, based on the look-up within the key index 186, extracts the push-through packet 114 having the key 8. The push-through packet 114 extracted by the packet selector 184 is represented as the push-through packet 194, including a web page 196 corresponding to the web page 116 of the push-through packet 114, and data 198 that is the same as the data 118 of the push-through packet 114. The extraction of the push-through packet 194 is represented by signal 8. The push-through packet 194 is then transmitted within signal 9 from the connect server 28 to the receiver device 26 and is received by the reception script 162 of the receiver device 26.

The reception script 162 subsequently transmits a signal 10 to the display 146 that includes a web page 206 with data 208. The web page 206 is the same as the web page 196 of the push-through packet 194 and the data 208 is the same as the data 198 of the push-through packet 194. The web page 206 and the data 208 are displayed within the page skeleton 144. When tracking the web page 206 and the data 208 back to their point of origin, it will be evident that they are the same as the web page 70 and the data 100 of the publisher device 24 in FIG. 2B. The user of the receiver device 26 can thus see the same web page and data as the user at the publisher device 24 and can provide assistance to the user of the publisher device 24 over the telephone to allow the user of the publisher device 24 to complete entry of the data 100 within the web page. As the user the of the publisher device 24 continues to complete the entry of the data 100, the data 208 on the receiver device 26 is also updated accordingly so that the user at the receiver device 26 can continue to monitor data entry of the user at the publisher device 24.

The masking rules 94 in FIG. 2B are designed by an administrator of the host server 22 in FIG. 2A. The masking rules 94 are used by the packet assembly script 90 to include a first subset of the data 100 as the data 108 in the push-through packet 104, while not including a second subset of the data 100 in the data 108. As such, only a portion of the data 100 will be viewable by a user of the receiver device 26 in FIG. 2D.

What should be noted is that the receiver device 26 in FIG. 2D only has access to the web page 62 of the host server 22 in FIG. 2A through the connect server 28 in FIG. 2C and the publisher device 24 in FIG. 2B. The receiver device 26 therefore does not direct access to the web page 62.

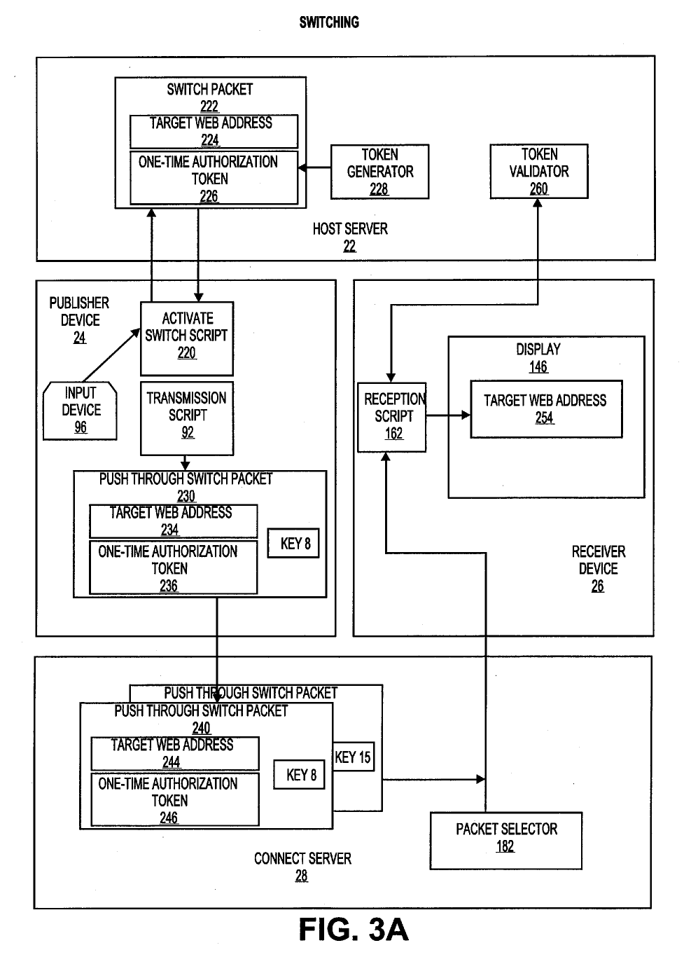

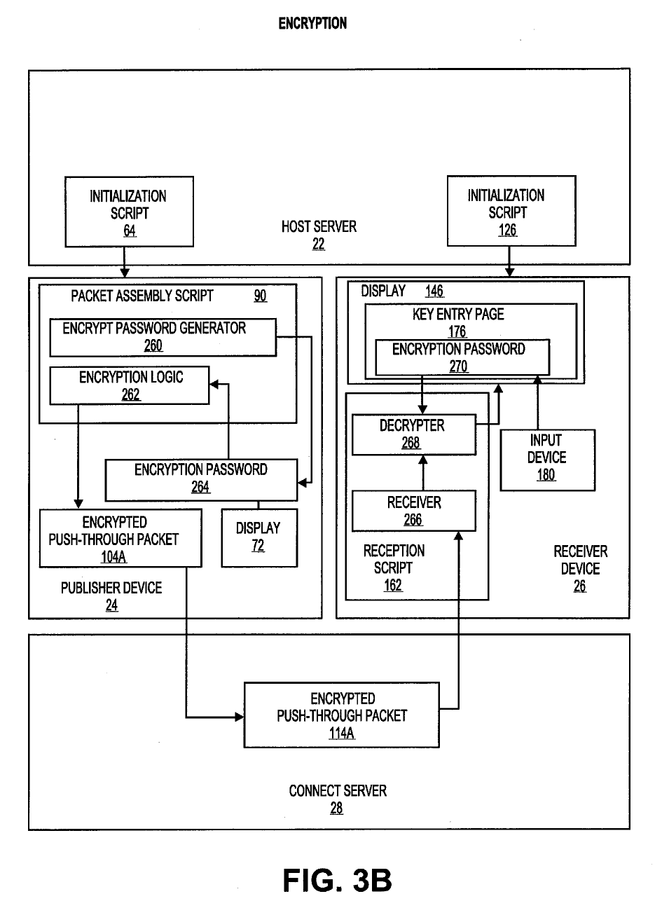

FIG. 3A illustrates how the functioning of the publisher device 24 and the receiver device is switched around so that the receiver device 26 now becomes the point of entry of data and the publisher device 24 becomes the device where the data is viewed. The input device 96 on the publisher device 24 is used to activate a switch script 220 by selecting a button. The switch script 220 then communicates with the host server 22 to receive a switch packet 222. The switch packet 222 includes a target web address 224 and a one-time authorization token 226. The one-time authorization token 226 is generated with a token generator 228.

Once the switch packet 222 is received by the publisher device 24, the transmission script 92 generates and transmits a push-through switch packet 230 that includes a target web address 234 and a one-time authorization token 236 that are the same as the target web address 224 and the one-time authorization token 226. The push-through switch packet 230 also includes the key 8.

The push-through switch packet 230 is received by the connect server 28 and stored as a push-through switch packet 240 with a target web address 244 and a one-time authorization token 246 that are the same as the target web address 234 and the one-time authorization token 236 of the push-through switch packet 230. The push-through switch packet 240 also includes the key 8. The push-through switch packet 240 is stored among a plurality of push-through switch packets represented by keys 8 and 15. The packet selector 182 selects the appropriate push-through switch packet 240 based on the keys and transmits the respective push-through switch packet 240 to the receiver device 26.

The reception script 162 extracts the target web address 244 and displays the target web address 244 as the target web address 254 within the display 146. The reception script 162 also extracts the target web address 244 from the push-through packet 240 and transmits the target web address 244 to the host server 22. The host server 22 includes a token validator 260 that receives the one-time authorization token 246 from the reception script 162 and validates the token against a token created by the token generator 228. Should a match exist, the receiver device 26 is provided access to a web page at the target web address 224 on the host server 22. The session illustrated in FIGS. 2A-D is then terminated and is reversed so that the web page, data and key are provided from the receiver device 26 through the connect server 28 to the publisher device 24. Prior to the switch, the overall data transmission follows the following basic sequence:
1. receiving a push-through packet from the publisher device at a connect server, including data entered at the publisher device and a key;
2. receiving a key from the receiver device;
3. comparing the keys received from the publisher and receiver devices to determine if a match exists; and
4. transmitting a push-through packet, including the data, from the connect server to the receiver device if a match exists between the keys received from the publisher and receiver devices.

Following switching, the data is transmitted according to the following basic sequence:
1. receiving a push-through packet from the receiver device at a connect server, including data entered at the receiver device and a key;
2. receiving a key from the publisher device;
3. comparing the keys received from the receiver and publisher devices to determine if a match exists; and
4. transmitting a push-through packet, including the data, from the connect server to the publisher device if a match exists between the keys received from the receiver and publisher devices.

FIG. 3B illustrates how the connect server 28 distributes encryption and decryption capabilities to the publisher and receiver devices 24 and 26. Encryption is an option that is selected by the host server 22. When the host server 22 transmits the initialization scripts 64 and 126 to the publisher and receiver devices 24 and 26, respectively, the initialization scripts 64 and 126 received by the devices 24 and 26 will indicate whether encryption and decryption sequences should be executed.

The packet assembly script 90 that is received from the connect server 28 as described with reference to FIG. 2B includes an encrypt password generator 260 and an encryption logic 262. The encrypt password generator 260 generates an encryption password 264 that is displayed on the display 72. The encryption password 264 is a one-time password and changes every time that the encrypt password generator 260 generates a new encryption password. The encryption logic 262 uses the encryption password 264 to create an encrypted push-through packet 104A. The encrypted push-though packet 104A is not readable by a party that may intercept the encrypted push-through packet 104A without being in possession of the encryption password 264. Further details of encryption should be evident to one of ordinary skill in the art. The encrypted push-though packet 104A is the same as the push-through packet 104 in FIG. 2B in all other respects.

The encrypted push-through packet 104A is transmitted from the publisher device 24 to the connect server 28 and is stored as an encrypted push-through packet 114A. The encrypted push-through packet 114A may be stored among the push-through packets 114 in FIG. 2C. The connect server 28 does not decrypt the encrypted push-through packet 114A. Furthermore, no analysis is carried out by the connect server 28 to determine whether a packet is an encrypted push-through packet or a non-encrypted push-through packet. The connect server 28 transmits the encrypted push-through packet 114A to the receiver device 26.

The reception script 162 that is received by the receiver device 26 from the connect server 28 as described with reference to FIG. 2D includes a receiver 266 and a decrypter 268. The encryption password 264 is communicated through a separate channel to the user of the receiver device 26. For example, the user of the publisher device 24 may give the encryption password 264 to the user of the receiver device 26 over the phone. The key entry page 176 that is displayed on the display 146 of the receiver device 26 further includes a field for entering an encryption password 270 utilizing the input device 180. The decrypter 268 utilizes the encryption password 270 to decrypt the encrypted push-through packet 114A received from the connect server 28. After the decrypter 268 has decrypted the encrypted push-through packet 114A, the reception script 162 proceeds as described with reference to FIG. 2D wherein the reception script 162 displays the web page 206 and the data 208 on the display 146. The decrypter 268 will however only be able to decrypt the encrypted push-through packet 114A if the encryption password 270 is the same as the encryption password 264. Should the encryption password 270 thus not be the same as the encryption password 264, the decrypter 268 will not be able to decrypt the encrypted push-through packet 114A and the reception script 162 will not be able to display the web page 206 and the data 208 on the display 146. Further details of decryption techniques should be evident to one of ordinary skill in the art.

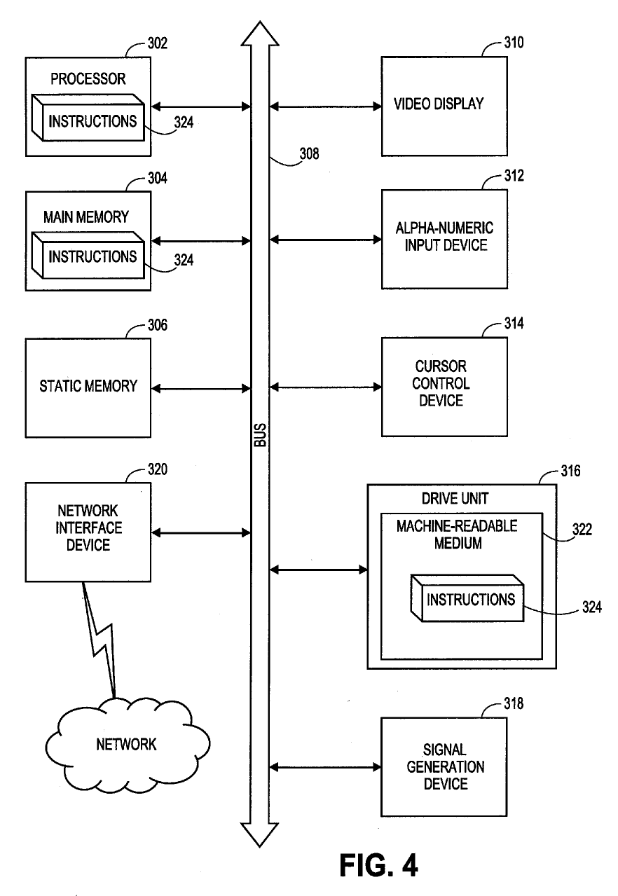

FIG. 4 shows a diagrammatic representation of a machine in the exemplary form of the network system 20 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary network system 20 includes a processor 302 (e.g., a central processing unit (CPU), a graphics processing unit (GPU), or both), a main memory 304 (e.g., read-only memory (ROM), flash memory, dynamic random access memory (DRAM) such as synchronous DRAM (SDRAM) or Rambus DRAM (RDRAM), etc.), and a static memory 306 (e.g., flash memory, static random access memory (SRAM, etc.), which communicate with each other via a bus 308.

The network system 20 may further include a video display 310 (e.g., a liquid crystal display (LCD) or a cathode ray tube (CRT)). The network system 20 also includes an alpha-numeric input device 312 (e.g., a keyboard), a cursor control device 314 (e.g., a mouse), a disk drive unit 316, a signal generation device 318 (e.g., a speaker), and a network interface device 320.

The disk drive unit 316 includes a machine-readable medium 322 on which is stored one or more sets of instructions 324 (e.g., software) embodying any one or more of the methodologies or functions described herein. The software may also reside, completely or at least partially, within the main memory 304 and/or within the processor 320 during execution thereof by the network system 20, the memory 304 and the processor 302 also constituting machine readable media. The software may further be transmitted or received over the Internet 30A and 30B via the network interface device 320.

While the instructions 324 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

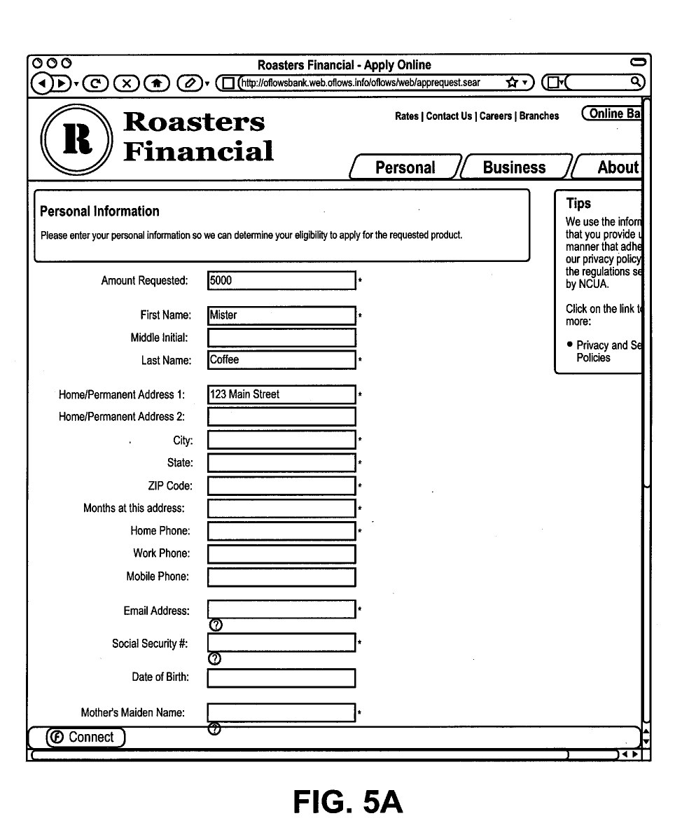

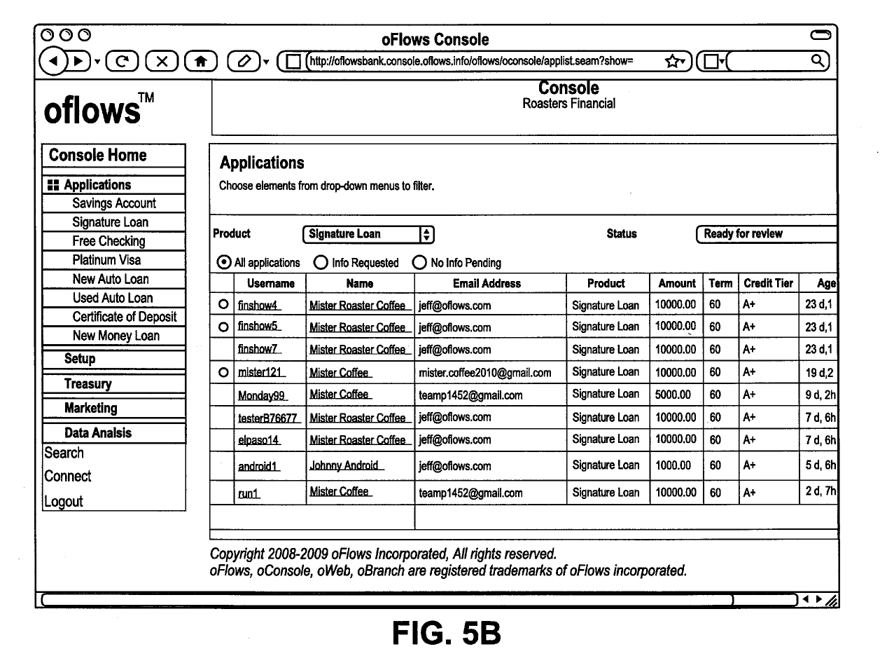

FIGS. 5A and B are screen shots of the publisher and receive devices, respectively, before the receiver device receives any data from the publisher device. The view includes an address box, and back and forward buttons, as is known in the art forming part of a browser. A user has typed in a URL in the address box and has selected “Enter” on a keyboard to transmit a web page request and has a received a web page in response to the request.

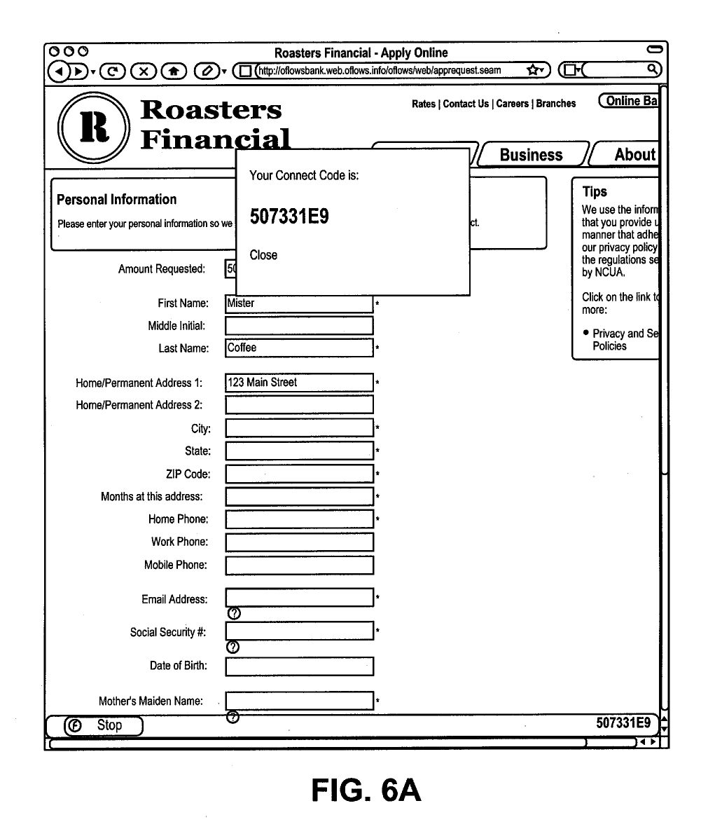

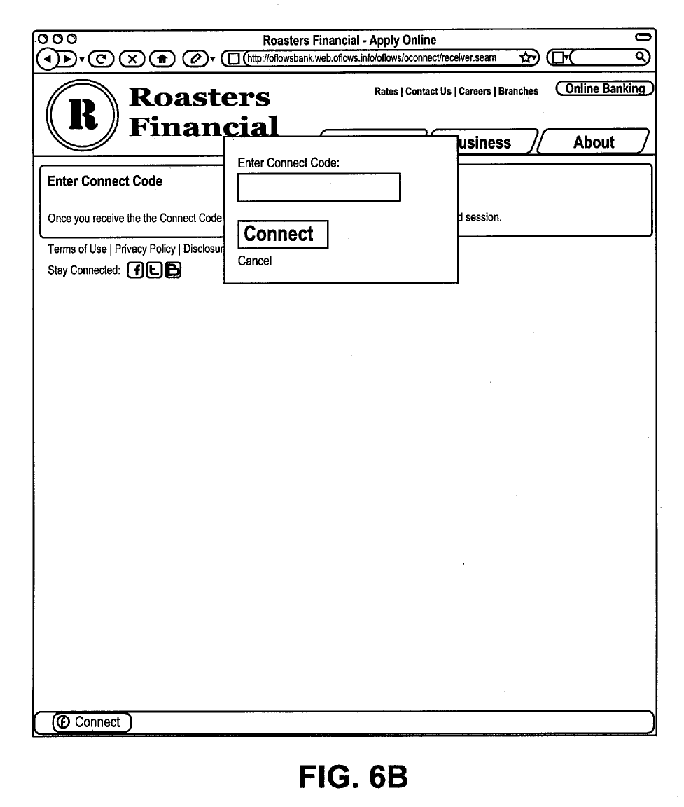

FIGS. 6A and B are screenshots of the publisher and receiver devices, respectively, after a key is generated and displayed on a display of the publisher device and a key entry page is displayed at the receiver device.

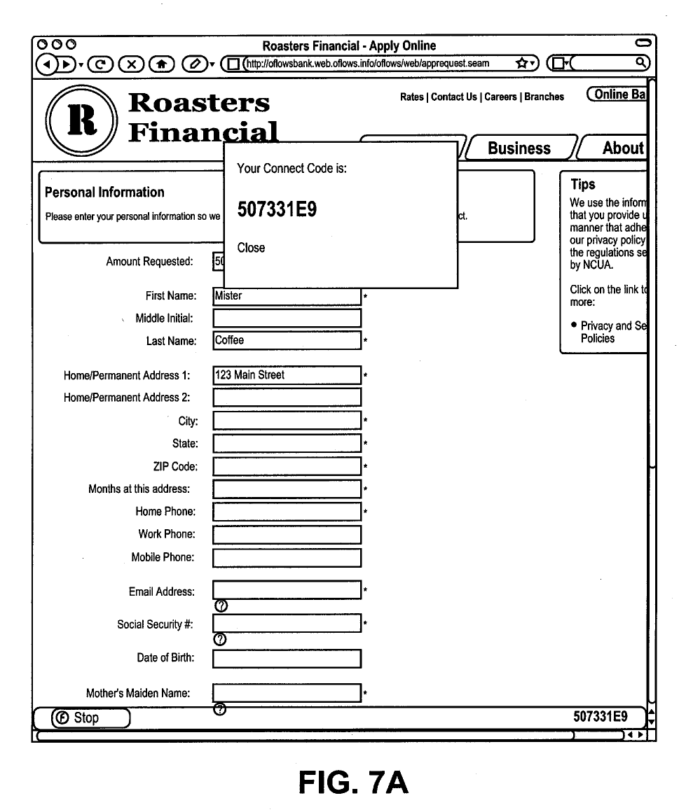

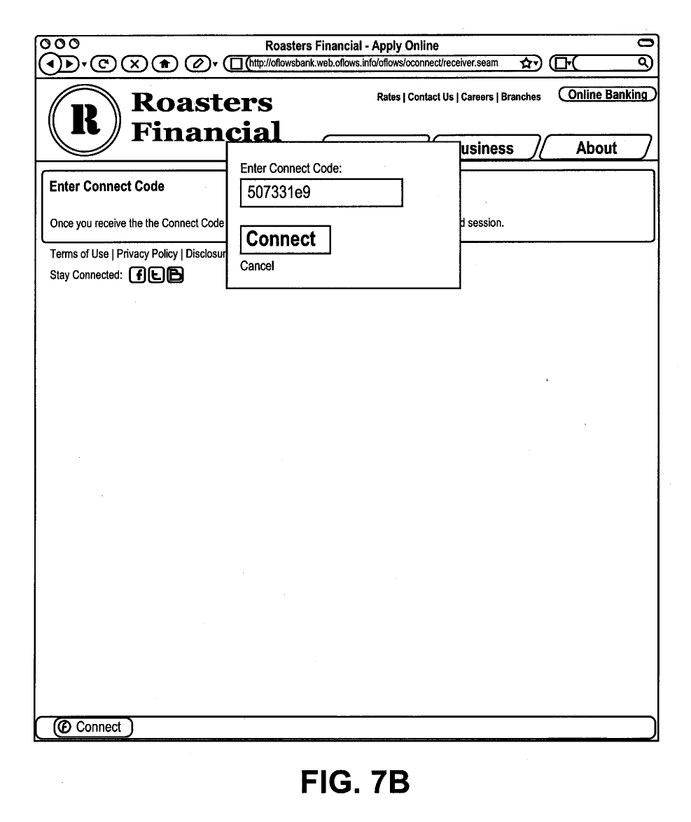

FIGS. 7A and B are screenshots of the publisher and receiver devices, respectively, after a user at the receiver device has entered the key.

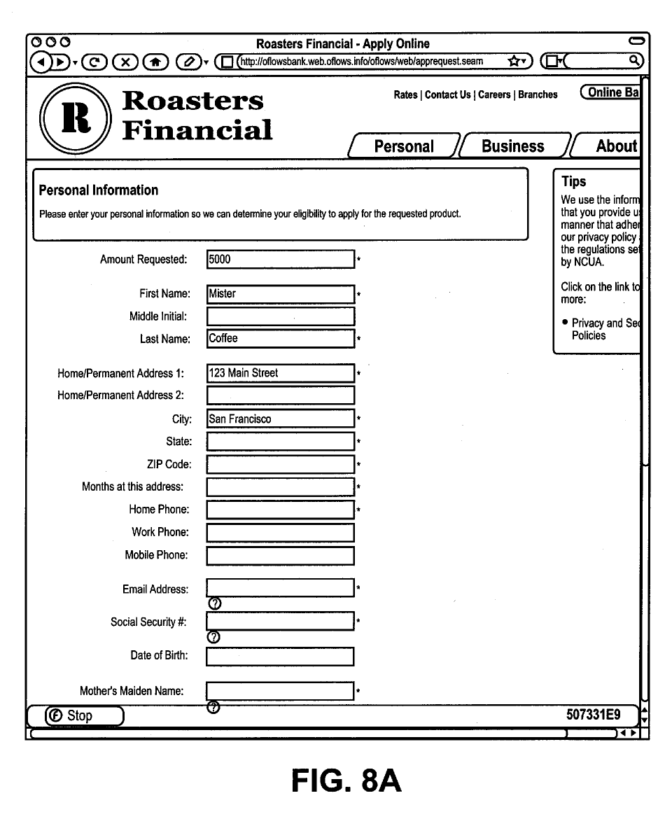

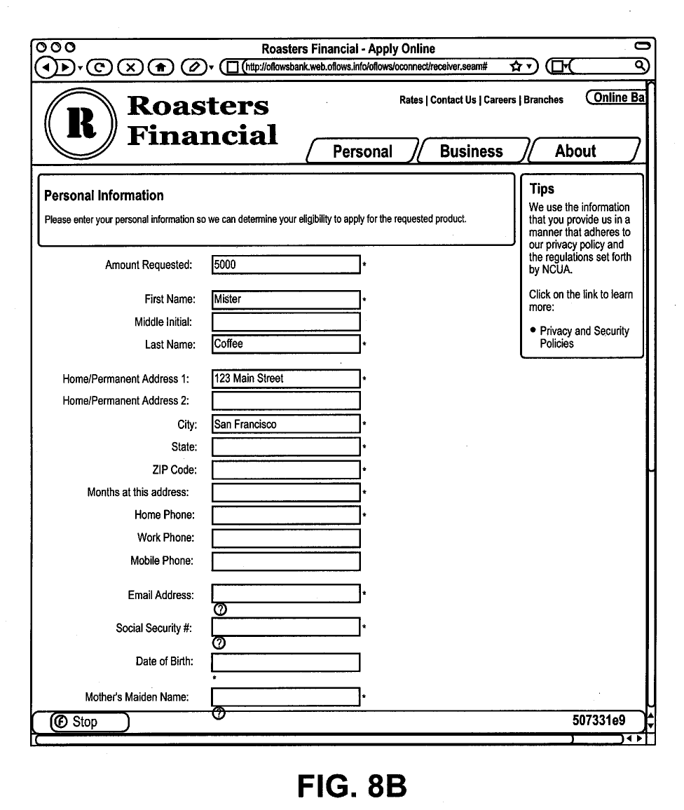

FIGS. 8A and B are screenshots of the publisher and receiver devices, respectively, after the same web page and data on the publisher device are received and displayed at the receiver device.

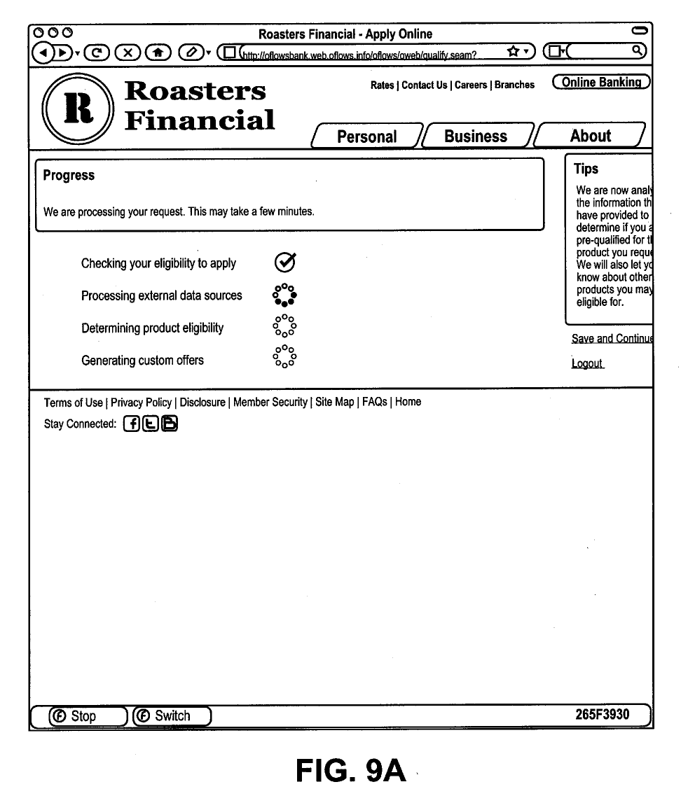

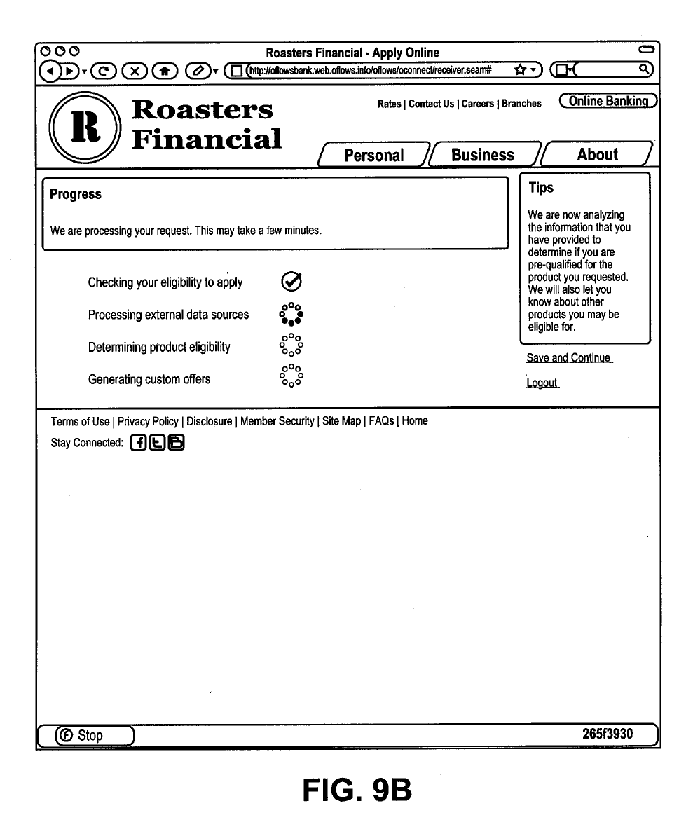

FIGS. 9A and 9B are screenshots of the publisher and receiver devices, respectively, after the data has been transmitted from the publisher device to the host server, and further illustrating the ability for the publisher device to switch so that it can receive data from the receiver device.

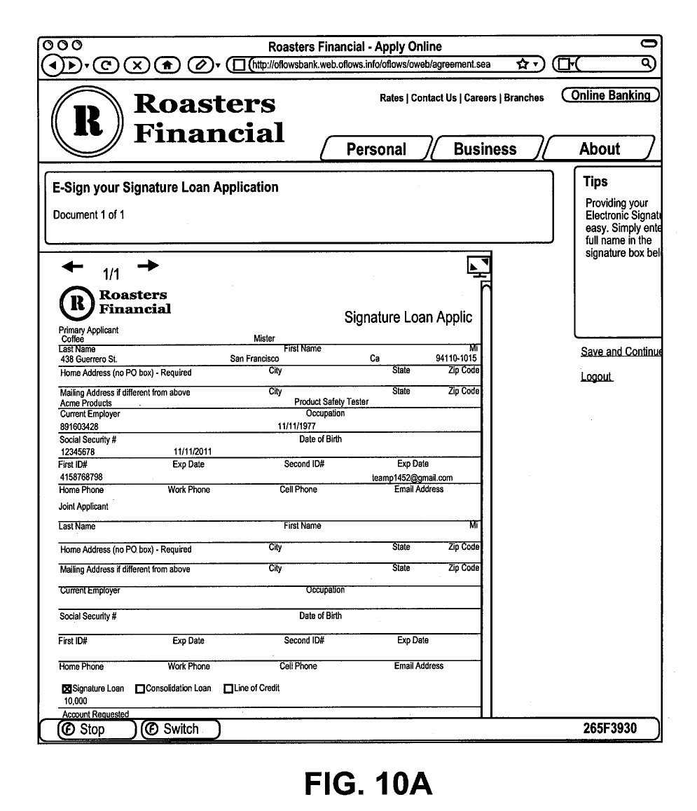

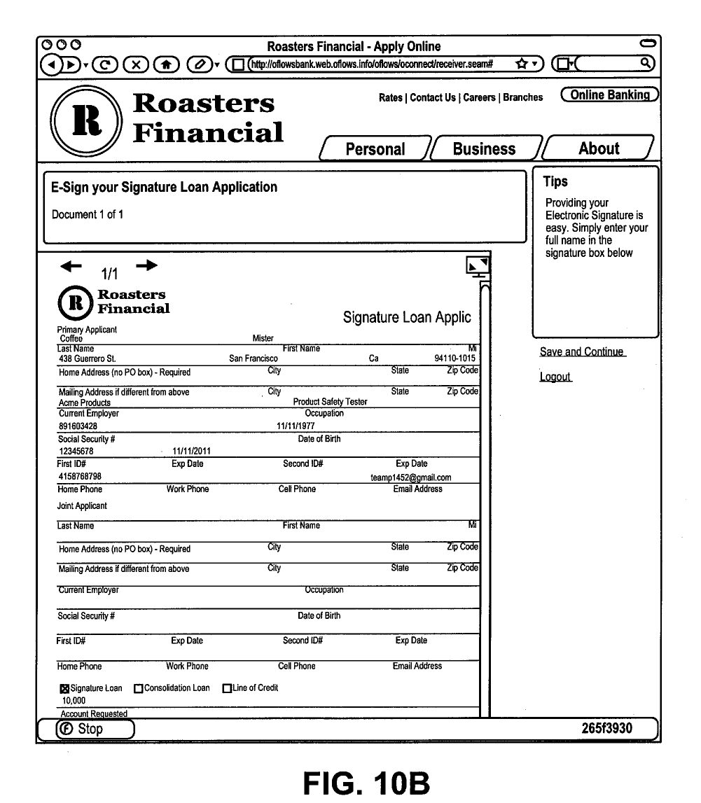

FIGS. 10A and B are screenshots of the publisher and receiver devices, respectively, after a completed form is returned from the host server to the publisher device and the same form is displayed at the receiver device.

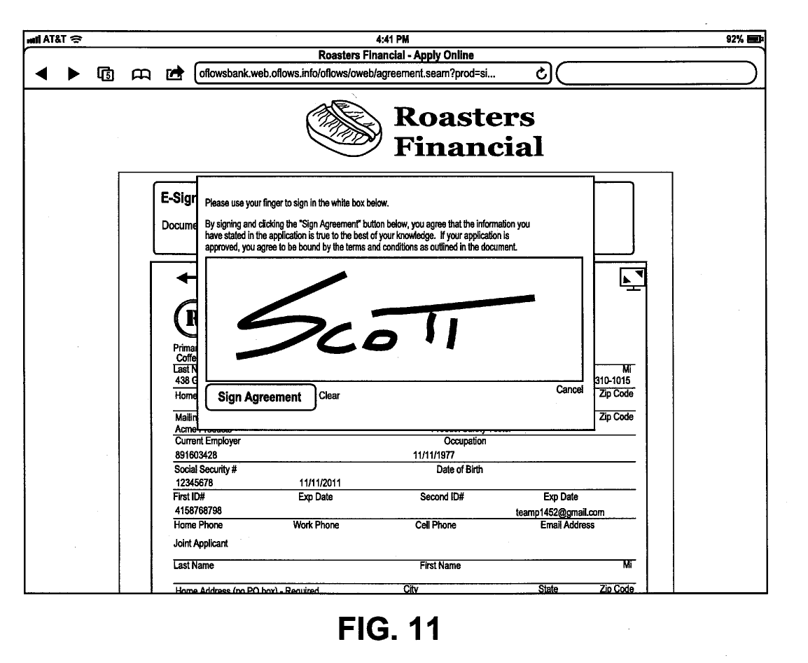

FIG. 11 is a screenshot of the receiver device after the user at the publisher device has electronically signed the form.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of communicating a display of information at a publisher device with a receiver device for display at the receiver device, the method comprising:
receiving a push-through packet from the publisher device at a connect server, including data entered at the publisher device and a key;
receiving a key from the receiver device;
comparing the keys received from the publisher and receiver devices to determine if a match exists; and
transmitting a push-through packet, including the data, from the connect server to the receiver device if a match exists between the keys received from the publisher and receiver devices.

2. The method of claim 1, further comprising:
transmitting a connect-to-publisher initialization packet from the connect server to the publisher device, including:
a packet assembly script that assembles the data and the key into the push-through packet at the publisher device; and
a transmission script that transmits the push-through packet from the publisher device to the connect server.

3. The method of claim 2, wherein the packet assembly script and the transmission script are connected to a clock of the publisher device and repeatedly at select intervals respectively assemble and transmit the push-through packet.

4. The method of claim 2, wherein the publisher device downloads a host-to-publisher packet from a host server, including a web page that is displayed at the publisher device for viewing of the data and the key and, an initialization script that downloads the connect-to-publisher initialization packet from the connect server onto the publisher device.

5. The method of claim 4, wherein the push-through packet that is assembled by the packet assembly script includes the web page.

6. The method of claim 2, further comprising:
generating a plurality of unique keys;
transmitting a plurality of connect-to-publisher initialization packets, each including a different one of the unique keys, to a plurality of respective publisher devices;
receiving a push-through packet from the respective one of the publisher devices, the respective push-through packet including the unique key transmitted to the respective publisher device;
storing the respective push-through packets; and
selecting the push-through packet based on the key received from the receiver device.

7. The method of claim 2, wherein the connect-to publisher initialization packet includes masking rules that are used by the packet assembly script to include a first subset of the data in the push-through packet while not including a second subset of the data in the push-through packet.

8. The method of claim 1, further comprising:
transmitting a connect-to-receiver initialization packet from the connect server to the receiver device, including:
a key entry page that is displayed at the receiver device with a field for displaying the key when the key is entered using an input device of the receiver device;
a key submission script that transmits the key from the receiver device to the connect server; and
a reception script that receives the push-through packet from the connect server for display of the data by the receiver device.

9. The method of claim 8, wherein the key submission script and the reception script are connected to a clock of the receiver device and repeatedly at select intervals respectively transmit the key and receive a respective push-through packet.

10. The method of claim 8, wherein the receiver device downloads a host-to-receiver packet from a host server, including a web page skeleton that is displayed at the receiver device, and an initialization script that downloads the connect-to-receiver initialization packet from the connect server onto the receiver device.

11. The method of claim 1, further comprising:
receiving a push-through packet from the receiver device at a connect server, including data entered at the receiver device and a key;
receiving a key from the publisher device;
comparing the keys received from the receiver and publisher devices to determine if a match exists; and
transmitting a push-through packet, including the data, from the connect server to the publisher device if a match exists between the keys received from the receiver and publisher devices.

12. The method of claim 1, further comprising:
transmitting a connect-to-publisher initialization packet from the connect server to the publisher device, including:
an encrypt password generator that generates an encryption password;
an encryption logic that encrypts the push-through packet with the encryption password to create an encrypted push-through packet;
receiving the encrypted push-through packet from the publisher device at the connect server;
transmitting the encrypted push-through packet from the connect server to the receiver device; and
transmitting a connect-to-receiver initialization packet from the connect server to the receiver device, including:
a receiver that receives the encrypted push-through packet;
a key entry page for entering an encryption password;
a decrypter that decrypts the encrypted push-through packet with the encryption password entered on the key entry page only if the encryption password entered on the key entry page matches the encryption password generated by the encryption logic.

13. A connect server for communicating a display of information at a publisher device with a receiver device for display at the receiver device, the connect server comprising:
a processor;
a storage medium connected to the processor;
a network interface device connected to the processor; and
a set of instructions and data on the storage medium, including:
a reception unit that executes the processor to receive a push-through packet through the network interface device from the publisher device including data entered at the publisher device, and for receiving a key from the receiver device;
a key comparison module that compares the keys received from the publisher and receiver devices to determine if a match exists; and
a transmission unit that executes the processor to transmit a push-through packet, including the data to the receiver device if a match exists between the keys received from the publisher and receiver devices.
